(19) United States
(12) Patent Application Publication
(10) Pub. No.: US 2019/0329559 A1
(43) Pub. Date: Oct. 31, 2019

(54) LIQUID EJECTING HEAD, LIQUID EJECTING APPARATUS, LIQUID CIRCULATING METHOD, AND LIQUID DISCHARGE METHOD

(71) Applicant: SEIKO EPSON CORPORATION, Tokyo (JP)

(72) Inventor: Kinya OZAWA, Shiojiri-Shi (JP)

(21) Appl. No.: 16/474,021

(22) PCT Filed: Dec. 7, 2017
(86) PCT No.: PCT/JP2017/043978

§ 371 Date: Jun. 26, 2019

(30) Foreign Application Priority Data
Dec. 26, 2016 (JP) 2016-250623

(51) Int. Cl. B41J 2/175

(52) U.S. Cl. CPC B41J 2/175

(57) ABSTRACT

A liquid ejecting head, a liquid ejecting apparatus, a liquid circulating method, and a liquid discharge method are provided, which can maintain circulation of liquid and prevent degradation of liquid discharge characteristics by reliably suppressing thickening of liquid near a nozzle opening and sedimentation of components of the liquid. The liquid ejecting head includes a first pressure generation chamber having a first pressure generation means, a second pressure generation chamber having a second pressure generation means, a communicating path that causes the first pressure generation chamber and the second pressure generation chamber to communicate with each other, a liquid supply path that supplies liquid to the first pressure generation chamber, and a liquid outflow path that flows out liquid from the second pressure generation chamber. The liquid ejecting head ejects liquid from a nozzle opening that communicates with either one of the first pressure generation chamber the second pressure generation chamber. A relationship among an inertance Mn of the nozzle opening, an inertance Ms1 of the liquid supply path, and an inertance Ms2 of the liquid outflow path satisfies Mn<Ms2<Ms1.

### TECHNICAL FIELD

The present invention relates to a liquid ejecting head, a liquid ejecting apparatus, a liquid circulating method, and a liquid discharge method, which eject liquid from nozzle openings.

### BACKGROUND ART

As a liquid ejecting apparatus, for example, there is an inkjet type recording apparatus including an inkjet type recording head (a recording head) having a pressure generation means composed of a piezoelectric element, a plurality of pressure generation chambers that cause the pressure generation means to generate pressure for discharging ink droplets, an ink supply path that individually supplies ink from a common liquid storage portion (manifold) to each pressure generation chamber, and an nozzle opening which is formed in each pressure generation chamber and discharges ink droplets.

The inkjet type recording apparatus discharges ink droplets from the nozzle openings to the outside by applying discharge energy to ink in the pressure generation chambers communicated with nozzle openings corresponding to a print signal and cause the ink droplets to land in a predetermined position on a recording medium such as paper.

Therefore, in the recording head of this kind of inkjet type recording apparatus, the nozzle opening faces the atmosphere. Therefore, the ink is thickened by evaporation of water through the nozzle opening or ink components are sedimented, so that discharge characteristics of the ink droplets are adversely affected. In other words, even when there is a small amount of thickened ink and/or sedimented components, the discharged amount and the discharge speed of ink droplets through the nozzle opening vary, so that a problem where landing variation occurs is generated.

To avoid such a problem, a recording head of an inkjet type recording apparatus is proposed where ink in a pressure generation chamber communicated with a nozzle opening is circulated so that the ink does not stay near the nozzle opening (for example, see PTL 1). The recording head of such a circulation method is configured so that ink is circulated between a first manifold and a second manifold, which are arranged on both sides of a plurality of pressure generation chambers having a nozzle opening and are communicated with each pressure generation chamber, through each pressure generation chamber.

On the other hand, a recording head of a circulation method, which includes a first pressure generation chamber having a first piezoelectric actuator and a second pressure generation chamber having a second piezoelectric actuator and causes both pressure generation chambers to be communicated with each other to circulates ink, is proposed (for example, see PTL 2).

### CITATION LIST

### Patent Literature

PTL 1: Japanese Unexamined Patent Application Publication No. 2014-61695
PTL 2: Japanese Unexamined Patent Application Publication No. 2015-134507

### SUMMARY OF INVENTION

### Technical Problem

However, PTL 1 and PTL 2 do not disclose at all how to design a circulation flow path of the recording head and how the circulation flow path is driven, so that a specific ink circulation method of the recording head is unknown.

Such a problem exists not only in an inkjet type recording head that discharges ink, but also in a liquid ejecting head that ejects liquid other than ink.

In view of the above situation, an object of the present invention is to provide a liquid ejecting head, a liquid ejecting apparatus, a liquid circulating method, and a liquid discharge method, which can maintain circulation of liquid in a flow path having two pressure generation chambers and prevent degradation of liquid discharge characteristics by reliably suppressing thickening of liquid near a nozzle opening and sedimentation of components of the liquid.

### Solution to Problem

An aspect of the present invention to solve the above problem is a liquid ejecting head which includes a first pressure generation chamber including a first pressure generation means, a second pressure generation chamber including a second pressure generation means, a communicating path that causes the first pressure generation chamber and the second pressure generation chamber to communicate with each other, a liquid supply path that supplies liquid to the first pressure generation chamber, and a liquid outflow path that flows out liquid from the second pressure generation chamber, and ejects liquid from a nozzle opening that communicates with the second pressure generation chamber. A relationship among an inertance Mn of the nozzle opening, an inertance Ms1 of the liquid supply path, and an inertance Ms2 of the liquid outflow path satisfies the following formula (1).

Mn<Ms2<Ms1 (1)

In this aspect, the value of the inertance Mn of the nozzle opening is smaller than the values of the other inertances Ms1 and Ms2, so that it is possible to circulate liquid near the nozzle opening and, in the nozzle opening, it is possible to reliably suppress drying of liquid immediately before being discharged and sedimentation of components contained in the liquid. Further, it is configured so that the inertance Ms2 of the liquid outflow path is smaller than the inertance Ms1 of the liquid supply path, so that it is possible to reliably circulate the liquid without providing a liquid circulating means such as a pump.

Here, it is preferable that the liquid ejecting head is configured so that a relationship between a flow path resistance Rs1 of the liquid supply path and a flow path resistance Rs2 of the liquid outflow path satisfies the following formula (2).

Rs2≈Rs1 (2)

Thereby, a flow path resistance difference between a liquid supply side and a liquid outflow side can be substantially ignored, and the liquid can be circulated without delay.

It is preferable that the liquid ejecting head includes a liquid circulating path that is connected between the liquid supply path and the liquid outflow path and circulates liquid and a drive means that drives the first pressure generation means and the second pressure generation means, and the drive means outputs a first drive signal that drives the first pressure generation means to contract the first pressure generation chamber, thereafter waits for a predetermined period of time and outputs a second drive signal that drives the second pressure generation means to contract the second pressure generation chamber, and thereby sequentially drives the first pressure generation means and the second pressure generation means. Thereby, the liquid can be efficiently circulated.

In the liquid ejecting head, it is preferable that the drive means outputs a micro vibration signal that micro-vibrates the first pressure generation means and the second pressure generation means. Thereby, the liquid near the nozzle opening is more easily flown by the micro vibration, so that it is possible to reliably suppress thickening of the liquid near the nozzle opening and sedimentation of components of the liquid.

The liquid ejecting head may be configured so that a first column composed of a plurality of the first pressure generation chambers and a second column composed of a plurality of the second pressure generation chambers are provided in parallel, positions of the columns in a direction along each column are different from each other, and the second pressure generation chamber is arranged between the first pressure generation chambers in the first column. Thereby, it is possible to integrate a head structure and improve resolution.

It is preferable that the liquid ejecting head is configured so that a relationship between compliance Cs1 of the first pressure generation means and compliance Cs2 of the second pressure generation means satisfies the following formula (3).

Cs2≤Cs1 (3)

Thereby, it is possible to prevent discharge of liquid from the nozzle opening due to drive of the first pressure generation means.

In the liquid ejecting head, it is preferable that when liquid is discharged, the drive means drives the first pressure generation means by outputting a third drive signal that contracts or expands the first pressure generation chamber within a natural period Tc of the liquid ejecting head after outputting the second drive signal to drive the second pressure generation means. Thereby, the first pressure generation means is driven at timing of the drive described above, so that it is possible to press the liquid near the nozzle opening so as not to discharge liquid from the nozzle opening and it is possible to prevent tailing of liquid discharged from the nozzle opening.

Another aspect of the present invention is a liquid ejecting apparatus having the liquid ejecting head described in any one of the aspects described above.

In this aspect, it is possible to realize a liquid ejecting apparatus which can maintain circulation of liquid in a flow path having two pressure generation chambers and prevent degradation of liquid discharge characteristics by reliably suppressing thickening of liquid near the nozzle opening and sedimentation of components of the liquid.

Further, another aspect of the present invention is a liquid circulating method that circulates liquid in a liquid ejecting head which includes a first pressure generation chamber including a first pressure generation means, a second pressure generation chamber including a second pressure generation means, a communicating path that causes the first pressure generation chamber and the second pressure generation chamber to communicate with each other, a liquid supply path that supplies liquid to the first pressure generation chamber, a liquid outflow path that flows out liquid from the second pressure generation chamber, and a liquid circulating path connected between the liquid supply path and the liquid outflow path, and which ejects liquid from a nozzle opening that communicates with the second pressure generation chamber. The liquid circulating method uses a liquid ejecting head where a relationship among an inertance Mn of the nozzle opening, an inertance Ms1 of the liquid supply path, and an inertance Ms2 of the liquid outflow path satisfies the formula (4) described below, and circulates the liquid by repeating a process in which the liquid supplied to the first pressure generation chamber through the liquid supply path is flown out to the liquid outflow path through the communicating path and the second pressure generation chamber and the liquid is returned to the liquid supply path through the liquid circulating path.

Mn<Ms2<Ms1 (4)

In this aspect, it is possible to maintain circulation of liquid in a flow path having two pressure generation chambers and prevent degradation of liquid discharge characteristics by reliably suppressing thickening of liquid near the nozzle opening and sedimentation of components of the liquid.

Further, another aspect of the present invention is a liquid discharge method that discharges liquid by using a liquid ejecting head which includes a first pressure generation chamber including a first pressure generation means, a second pressure generation chamber including a second pressure generation means, a communicating path that causes the first pressure generation chamber and the second pressure generation chamber to communicate with each other, a liquid supply path that supplies liquid to the first pressure generation chamber, a liquid outflow path that flows out liquid from the second pressure generation chamber, and a drive means that drives the first pressure generation means and the second pressure generation means, and ejects liquid from a nozzle opening that communicates with the second pressure generation chamber, and which is configured so that a relationship among an inertance Mn of the nozzle opening, an inertance Ms1 of the liquid supply path, and an inertance Ms2 of the liquid outflow path satisfies the formula (5) described below. The drive means outputs a first drive signal that drives the first pressure generation means, thereafter waits for a predetermined period of time and outputs a second drive signal that drives the second pressure generation means, and thereby sequentially drives the first pressure generation means and the second pressure generation means to discharge liquid from the nozzle opening.

Mn<Ms2<Ms1 (5).

In this aspect, it is possible to maintain circulation of liquid in a flow path having two pressure generation chambers and prevent degradation of liquid discharge characteristics by reliably suppressing thickening of liquid near the nozzle opening and sedimentation of components of the liquid.

### BRIEF DESCRIPTION OF DRAWINGS

FIG. 1 is a cross-sectional view of a recording head of a first embodiment.

FIG. 2 is an enlarged cross-sectional view in which an essential part of FIG. 1 is enlarged.

FIG. 3 is a cross-sectional view taken along line A-A′ in FIG. 1.

FIG. 4 is a block diagram showing a control configuration example of the recording head of the first embodiment.

FIG. 5 is a block diagram showing a control configuration example of the recording head of the first embodiment.

FIG. 6 is a diagram showing a drive signal example when the recording head of the first embodiment discharges ink.

FIG. 7 is a diagram showing a drive signal example when the recording head of the first embodiment does not discharge ink.

FIG. 8 is a diagram showing a drive signal example when a recording head of a second embodiment discharges ink.

FIG. 9 is a cross-sectional view showing flow paths in a recording head of a third embodiment.

FIG. 10 is a perspective view showing an overview of an example of an inkjet type recording apparatus.

### DESCRIPTION OF EMBODIMENTS

Hereinafter, embodiments of the present invention will be described with reference to the drawings. The explanation below shows an aspect of the present invention and can be arbitrarily changed without departing from the scope of the invention. In the drawings, members denoted by the same reference numerals indicate the same members, and descriptions thereof are appropriately omitted. X, Y, and Z represent three spatial axes perpendicular to each other. In the present description, directions along these axes are defined as a first direction X (X direction, a second direction Y (Y direction), and a third direction Z (Z direction), respectively. In each drawing, a direction indicated by an arrow is defined as a positive (+) direction, and a direction opposite to the arrow is defined as a negative (−) direction. The X direction and the Y direction represent in-plane directions of each component, and the Z direction represents a thickness direction or a lamination direction of each component.

Shapes, sizes, layer thicknesses, relative positional relationships, recurring units, and the like of components, that is, portions shown in the drawings may be exaggerated so as to explain the present invention. Further, the term “on” in the present description does not limit that the positional relationship between components is “directly on”. For example, an expression such as “the first electrode on the substrate” or “the piezoelectric layer on the first electrode” does not exclude a situation where another component is included between the substrate and the first electrode or between the first electrode and the piezoelectric layer.

### First Embodiment

(Liquid Ejecting Head)

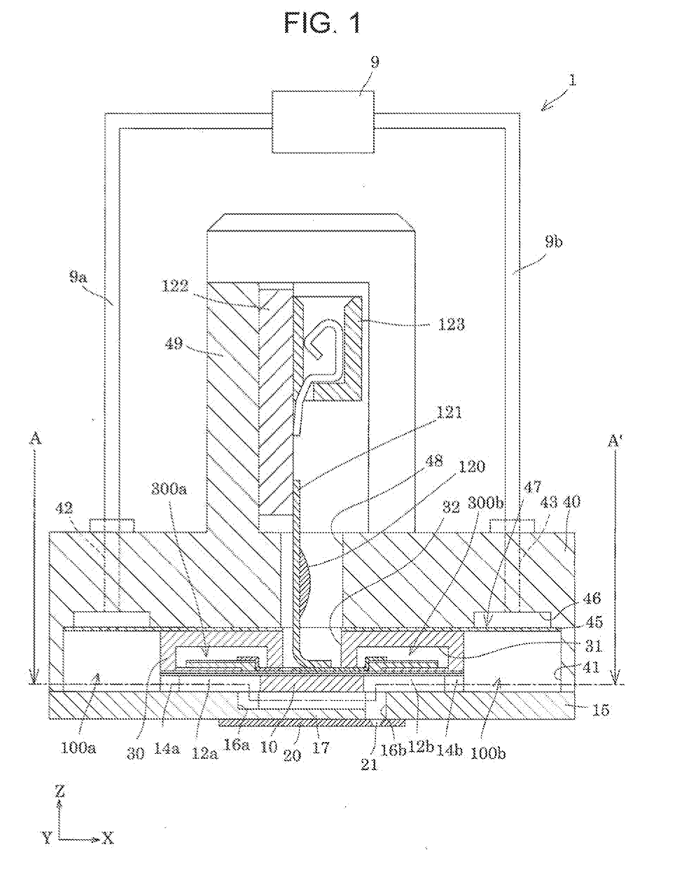

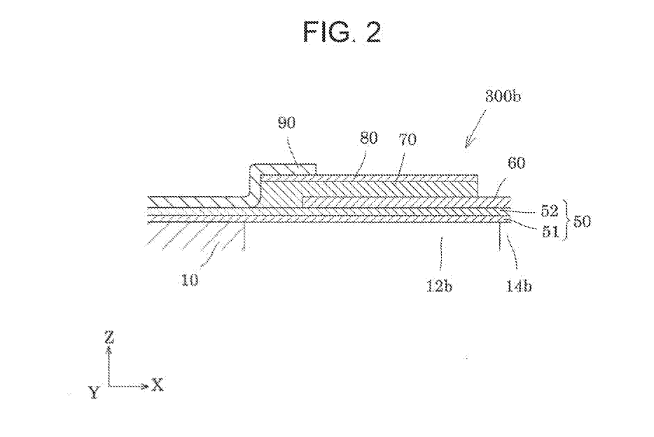

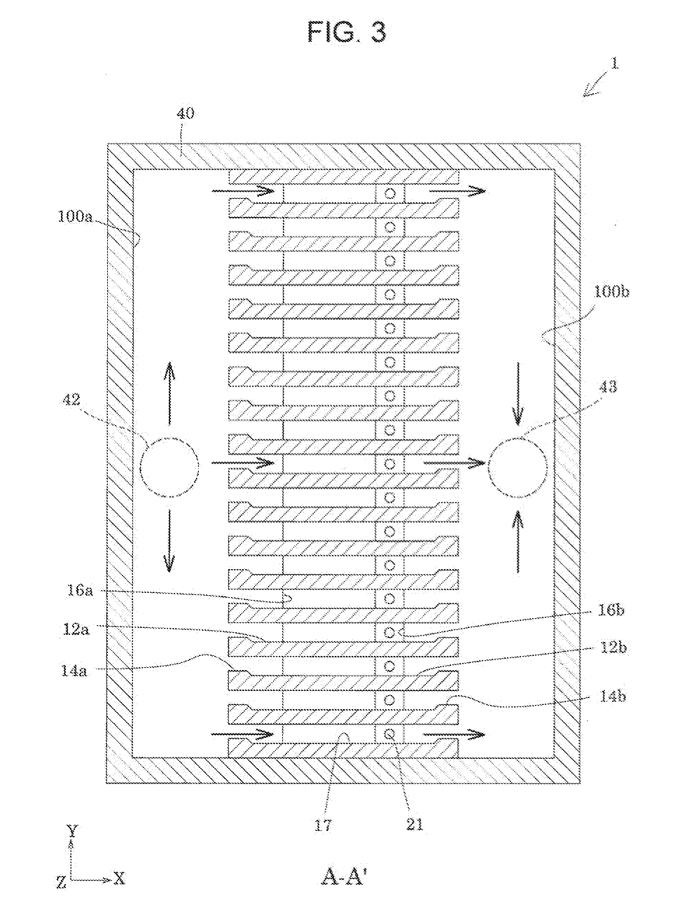

First, an inkjet type recording head (hereinafter referred to as a recording head) mounted on an inkjet type recording apparatus (hereinafter referred to as a recording apparatus), which is an example of a liquid ejecting head mounted on a liquid ejecting apparatus, will be described with reference to FIGS. 1 to 3. FIG. 1 is a cross-sectional view of the recording head of the first embodiment. FIG. 2 is an enlarged cross-sectional view in which an essential part of FIG. 1 is enlarged. FIG. 3 is a cross-sectional view taken along line A-A′ in FIG. 1.

As shown in the drawings, a flow path forming substrate (hereinafter referred to as a substrate) 10 is composed of a silicon (Si) single crystal substrate of a predetermined plane orientation. A material of the substrate 10 is not limited to Si but may be SOI, glass, metal, or the like. An elastic film 51 composed of silicon dioxide (SiO₂) is formed on one surface of the substrate 10. On the other surface of the substrate 10 (a surface opposite to the elastic film 51), a plurality of first pressure generation chambers 12a are provided by being substantially linearly aligned over the +Y direction. Further, on one side (the +X direction side) of the longitudinal direction of the plurality of first pressure generation chambers 12a, a plurality of second pressure generation chambers 12b are provided by being substantially linearly aligned over the +Y direction and being adjacent to a column composed of the plurality of first pressure generation chambers 12a. The plurality of first pressure generation chambers 12a and the second pressure generation chambers 12b are provided so that their positions in the +Y direction are the same.

A manifold 100a is provided to be communicated with one end portion side (the −X direction side) of the first pressure generation chamber 12a in the longitudinal direction through a liquid supply path 14a. The manifold 100a is a common liquid chamber common to the plurality of first pressure generation chambers 12a. Thereby, ink is supplied from an ink tank 9, which is a liquid storage means, to the manifold 100a and the ink is supplied to the first pressure generation chamber 12a through the liquid supply path 14a. The liquid supply path 14a is formed to have a width (an opening) smaller than that of the first pressure generation chamber 12a, so that the liquid supply path 14a maintains flow path resistance of the ink supplied from the manifold 100a to the first pressure generation chamber 12a (flow path resistance Rs1 of the liquid supply path 14a described later) constant. In the present embodiment, a plurality of individual flow paths communicated with the manifold 100a, which is a common flow path, are formed by the plurality of first pressure generation chambers 12a and liquid supply paths 14a.

On the opposite side (the +X direction side) of the first pressure generation chamber 12a, a manifold 100b is formed to be communicated through a liquid outflow path 14b. This configuration is the same as that of the first pressure generation chamber 12a, the liquid supply path 14a, and the manifold 100a except that arrangement is opposite (the +X direction side). The liquid outflow path 14b maintains flow path resistance of the ink flowing out from the second pressure generation chamber 12b to the manifold 100b (flow path resistance Rs2 of the liquid outflow path 14b described later) constant.

A communicating plate 15 is provided on an opening surface side (a side opposite to the elastic film 51) of the substrate 10 through an adhesive, a thermal bonding film, or the like, and a lower side (−Z direction side) of the first pressure generation chamber 12a and the second pressure generation chamber 12b is sealed by the communicating plate 15. In portions facing an end portion on the +X direction side of the first pressure generation chamber 12a and an end portion on the −X direction side of the second pressure generation chamber 12b of the communicating plate 15, a communicating path 16a penetrating halfway in the thickness direction and a communicating path 16b penetrating in the thickness direction, which are communicated with the first pressure generation chamber 12a and the second pressure generation chamber 12b, are provided, respectively. The communicating path 16a is independently provided for each first pressure generation chamber 12a. The communicating path 16b is independently provided for each second pressure generation chamber 12b. Therefore, the communicating paths 16a and the communicating paths 16b are substantially linearly provided in parallel in the same manner as the columns formed by the first pressure generation chambers 12a and the second pressure generation chambers 12b, respectively.

A communicating path 17 is provided between the communicating path 16a and the communicating path 16b of the communicating plate 15. The communicating paths 17 are provided between the column formed by the first pressure generation chambers 12a and the column formed by the second pressure generation chambers 12b adjacent to the column formed by the first pressure generation chambers 12a. An upper side (+Z direction side) of the communicating path 17 sealed by the substrate 10. The communicating path 17 is independently provided for each first pressure generation chamber 12a and second pressure generation chamber 12b along a parallel arrangement direction (+Y direction) of the first pressure generation chambers 12a and the second pressure generation chambers 12b. The first pressure generation chamber 12a is provided to be communicated with one end side (−X direction side) of the communicating path 17 through the communicating path 16a. The second pressure generation chamber 12b is provided to be communicated with the other end side (+X direction side) of the communicating path 17 through the communicating path 16b.

The communicating plate 15 has an area (a bonding surface with the substrate 10) larger than that of the substrate 10. On the communicating plate 15, the manifolds 100a and 100b are partitioned between the communicating plate 15 and a compliance substrate 40 on the outsides of the liquid supply path 14a and the liquid outflow path 14b of the substrate 10. Therefore, the communicating plate 15 has substantially the same area as that of the compliance substrate 40 in plan view from a surface on a nozzle plate 20 side (a surface on the −Z direction side).

The nozzle plate 20 is provided on a surface of the communicating plate 15 opposite to the substrate 10 through an adhesive, a thermal bonding film, or the like. The nozzle plate 20 is provided with a nozzle opening 21 communicated with the second pressure generation chamber 12b in the thickness direction through the communicating path 16b. The nozzle plate 20 is composed of metal such as stainless steel, glass ceramics, silicon single crystal substrate, or the like.

The nozzle plate 20 is formed to be smaller than the communicating plate 15. The nozzle plate 20 has a size covering (sealing) an opening of the communicating path 16b provided in the communicating plate 15 on the nozzle plate 20 side. In other words, the nozzle plate 20 does not cover an entire surface of the communicating plate 15 but has a size covering the communicating path 16b. It is possible to reduce cost by forming the nozzle plate 20 so that the area (a bonding surface with the communicating plate 15) of the nozzle plate 20 is small.

As shown in FIG. 2, the elastic film 51 is formed on a surface opposite to the opening surface (a surface facing the communicating plate 15) of the substrate 10, and an insulator film 52 composed of, for example, zirconium oxide (ZrO₂) is formed on the elastic film 51. Thereby, a vibration plate 50 is formed. Further, at positions corresponding to the first pressure generation chambers 12a and the second pressure generation chambers 12b on the insulator film 52, first electrodes 60, piezoelectric layers 70, and second electrodes 80 are laminated sequentially by a film forming method and a lithography method, and form first piezoelectric elements 300a and second piezoelectric elements 300b, which are piezoelectric actuators (pressure generation means). In general, an electrode of one of the first piezoelectric element 300a and the second piezoelectric element 300b is used as a common electrode, and the other electrode is used as an individual electrode. The individual electrode is formed by being patterned for each first pressure generation chambers 12a and second pressure generation chambers 12b along with the piezoelectric layer 70 after film formation of electrode film. In the present embodiment, the first electrode 60 is formed as the common electrode and the second electrode 80 is formed as the individual electrode. However, even when these electrodes are formed in the opposite way according to an arrangement of drive circuits and wirings, there is no problem in the performance of the piezoelectric actuators.

In the present embodiment, the vibration plate 50 composed of the elastic film 51 and the insulator film 52 is formed. However, the vibration plate 50 is not limited to this configuration if the vibration plate 50 functions as a vibration plate. For example, only the first electrode 60 may function as a vibration plate without providing the elastic film 51 and the insulator film 52. Alternatively, the first piezoelectric element 300a and the second piezoelectric element 300b may also substantially function as a vibration plate.

A lead electrodes 90 composed of, for example, gold (Au) or the like is respectively connected to the first piezoelectric element 300a and the second electrode 80 which is the individual electrode of the second piezoelectric element 300b. The lead electrode 90 is connected with a wiring substrate 121, such as COF, which is a flexible wiring provided with a drive circuit 120 such as a drive IC. A drive signal from the drive circuit 120 is outputted to the first piezoelectric element 300a and second piezoelectric element 300b through the wiring substrate 121 and the lead electrode 90.

Protective substrates 30, each of which has a piezoelectric element holding portion 31 that can secure a space in which movements of the first piezoelectric element 300a and the second piezoelectric element 300b are not obstructed, are bonded to areas on the substrate 10 facing the first piezoelectric element 300a and the second piezoelectric element 300b through an adhesive, a thermal bonding film, or the like. The first piezoelectric element 300a and the second piezoelectric element 300b are formed in the piezoelectric element holding portions 31, so that the first piezoelectric element 300a and the second piezoelectric element 300b are protected in state where they are hardly affected by the effect of an external environment. In the present embodiment, the first piezoelectric element 300a and the second piezoelectric element 300b are provided corresponding to the first pressure generation chamber 12a and the second pressure generation chamber 12b, respectively and independently, so that the piezoelectric element holding portion 31 is provided for each piezoelectric element over lines juxtaposed in the width direction (+X direction) of the first piezoelectric element 300a and the second piezoelectric element 300b and the piezoelectric element holding portion 31 is independently provided for each line of the first piezoelectric element 300a and the second piezoelectric element 300b.

In the protective substrate 30, a through hole 32 provided to penetrate the protective substrate 30 in the thickness direction is provided between the two piezoelectric element holding portions 31. End portions of the lead electrodes 90 extracted from the first piezoelectric element 300a and the second piezoelectric element 300b on the substrate 10 are extended to expose in the through hole 32, and the lead electrodes 90 and the wiring substrate 121 are electrically connected in the through hole 32.

In the present embodiment, the protective substrate 30 is formed to have substantially the same size (area on a bonding surface side) as that of the substrate 10. As materials of the protective substrate 30, for example, there are glass, ceramic material, metal, resin, and the like. However, it is more preferable that the protective substrate 30 is formed of a material whose thermal expansion rate is substantially the same as that of the substrate 10, so that in the present embodiment, the protective substrate 30 is formed by using a Si single crystal substrate whose material is the same as that of the substrate 10.

The compliance substrate 40 that forms the manifolds 100a and 100b is bonded to surfaces of the protective substrates 30 opposite to the substrate 10.

The compliance substrate 40 has a recessed portion 41 that holds the substrate 10 on the protective substrates 30 side and internally holds the protective substrates 30. The recessed portion 41 has an area larger than a surface where the protective substrates 30 are bonded to the substrate 10 and has a depth substantially equal to a thickness of a portion where the substrate 10 and the protective substrates 30 are bonded together. The communicating plate 15 seals an opening surface of the recessed portion 41, so that the protective substrates 30 and the substrate 10 are held in the recessed portion 41. Specifically, surfaces of the protective substrates 30 opposite to the substrate 10 are bonded to an inner surface of the recessed portion 41, and a surface of the communicating plate 15 facing the substrate 10 is bonded to a surface of the opening of the recessed portion 41 (a surface around the recessed portion 41) of the compliance substrate 40. Thereby, the substrate 10 and the protective substrates 30 are held in the recessed portion 41, and the manifolds 100a and 100b, which are spaces partitioned by the compliance substrate 40 and the communicating plate 15, are formed on the outsides (end faces) of the liquid supply path 14a and the liquid outflow path 14b of the substrate 10 and the protective substrates 30. In the present embodiment, the protective substrates 30 and the substrate 10 are held in a central portion of the recessed portion 41 of the compliance substrate 40, and the manifolds 100a and 100b communicated with the first pressure generation chambers 12a and the second pressure generation chambers 12b, respectively, are formed on both sides of the central portion of the recessed portion 41.

The compliance substrate 40 is provided with a supply path 42 that is communicated with the manifold 100a and supplies ink to the manifold 100a and an outflow path 43 that is communicated with the manifold 100b and flows out ink flowing from the communicating path 17. Thereby, the manifold 100a can supply ink supplied from the supply path 42 that is provided to penetrate the compliance substrate 40 in the thickness direction to the second pressure generation chambers 12b from the liquid supply paths 14a provided to be distributed to the first pressure generation chambers 12a through the communicating paths 17. The manifold 100b can flow out the ink to the outflow path 43 provided to penetrate the compliance substrate 40 in the thickness direction from the liquid outflow paths 14b provided to the second pressure generation chambers 12b to which the ink is supplied through the communicating paths 17 communicated with the first pressure generation chambers 12a.

The supply path 42 is arranged to be communicated with a central portion of an upper portion (on the side opposite to the communicating plate 15) of the manifold 100a provided at an end portion of one side (−X direction side) in the longitudinal direction of the first pressure generation chamber 12a of the substrate 10. On the other hand, the outflow path 43 is arranged on the side opposite to the supply path 42 in the parallel arrangement direction of the second pressure generation chambers 12b.

The supply path 42 and the outflow path 43 are connected with a supply pipe 9a and an outflow pipe 9b that are a pipe-shaped member such as a tube connected to an ink tank 9 where external ink is stored. Specifically, one end portion of the supply pipe 9a is connected to the ink tank 9 and the other end portion is connected to the supply path 42, and the supply pipe 9a supplies the ink stored in the ink tank 9 to the manifold 100a. On the other hand, one end portion of the outflow pipe 9b is connected to the ink tank 9 and the other end portion is connected to the outflow path 43, and the outflow pipe 9b flows out the ink to the ink tank 9 through the manifold 100b. A liquid circulating means such as a pump may be provided in the middle of the outflow pipe 9b as needed. The ink is returned from the manifold 100b to the ink tank 9 by pressure of the liquid circulating means.

A sealing film 45 is provided on a bottom surface of the recessed portion 41 of the compliance substrate 40 to which the protective substrate 30 is bonded. The sealing film 45 is composed of a low-rigidity and flexible material such as, for example, polyphenylene sulfide (PPS), and parts of the manifolds 100a and 100b are sealed by the sealing film 45.

Areas of the compliance substrate 40 facing the manifolds 100a and 100b are space portion 46 having a recessed shape, so that parts of the manifolds 100a and 100b on the compliance substrate 40 side (on the side opposite to the communicating plate 15) are flexible portions 47 that are sealed by only the sealing film 45 and are flexible and deformable.

The compliance substrate 40 is provided with a connection port 48 that penetrates the compliance substrate 40 in the thickness direction and is communicated with the through hole 32 of the protective substrate 30. The wiring substrate 121 inserted into the connection port 48 is inserted into the through hole 32 of the protective substrate 30 and connected with the lead electrode 90. A wall portion 49 is provided to an opening edge portion of the connection port 48 on the side opposite to a surface where the recessed portion 41 of the compliance substrate 40 opens. The wall portion 49 holds the wiring substrate 121 and a connection substrate 122 connected to the wiring substrate 121. The connection substrate 122 is composed of a rigid substrate provided with a connector 123 to which an external wiring is connected. The connection substrate 122 is electrically connected with the wiring substrate 121 connected to the lead electrode 90. An external wiring not shown in the drawings is connected to the connector 123 of the connection substrate 122, so that a print signal from the external wiring is outputted to the wiring substrate 121.

Here in a flow path of a recording head 1 of the present embodiment, a relationship among an inertance Mn of the nozzle opening 21, an inertance Ms1 of the liquid supply path 14a, and an inertance Ms2 of the liquid outflow path 14b satisfies the following formula (6).

Mn<Ms2<Ms1 (6)

In general, the inertances Mn, Ms1, and Ms2 can be obtained as follows: When a flow path has a hollow rectangular parallelepiped shape, the inertances Mn, Ms1, and Ms2 of the flow path are (ρl/wh), and when the flow path has a cylindrical body, the inertances Mn, Ms1, and Ms2 of the flow path are (ρl/πr²). In the inertances Mn, Ms1, and Ms2, ρ is the density of ink, l is the length of the flow path, w is the width of the flow path, h is the height of the flow path, and r is the radius of the flow path.

Therefore, when the shapes of the nozzle opening 21, the liquid supply path 14a, and the liquid outflow path 14b can be approximated by a hollow rectangular parallelepiped shape, the inertances Mn, Ms1, and Ms2 can be obtained by (ρl/wh), and when these shapes can be approximated by a cylindrical body, the inertances Mn, Ms1, and Ms2 can be obtained by (ρl/πr²). Even when such approximations cannot be performed, it is possible to obtain desired inertances Mn, Ms1, and Ms2 by similar calculation using integration. When designing a flow path of any shape so that the length is large with respect to the opening, the inertance value increases and ink becomes difficult to flow.

As shown in the formula (6), when the value of the inertance Mn of the nozzle opening 21 is smaller than those of Ms2 and Ms1, ink near the nozzle opening 21 can be circulated, so that in the nozzle opening 21, it is possible to reliably suppress drying of ink immediately before being discharged and sedimentation of components contained in the ink. Further, when it is configured so that the inertance Ms2 of the liquid outflow path 14b is smaller than the inertance Ms1 of the liquid supply path 14a, it is possible to reliably circulate the ink without providing a liquid circulating means such as a pump. Thereby, it is possible to improve cost performance.

On the other hand, when the relationship among the inertance Mn of the nozzle opening 21, the inertance Ms1 of the liquid supply path 14a, and the inertance Ms2 of the liquid outflow path 14b does not satisfy the following formula (6), for example, when the value of the inertance Ms1 of the liquid supply path 14a is smaller than the other inertance values, the ink easily flows to the ink tank 9, that is, the ink flows back, so that the ink cannot be circulated in the flow paths of the recording head 1. When the value of the inertance Ms2 of the liquid outflow path 14b is smaller than the other inertance values, the ink can be circulated in the flow paths of the recording head 1. However, the ink becomes difficult to flow to the nozzle opening 21, so that it is difficult to discharge ink. Further, even when the value of the inertance Ms1 of the liquid supply path 14a is smaller than the other inertance values, if the value of the inertance Ms2 of the liquid outflow path 14b is greater than the inertance Ms1 of the liquid supply path 14a, the ink easily flows back and becomes difficult to be circulated.

It is preferable that the flow paths are configured so that the relationship between the flow path resistance Rs1 of the liquid supply path 14a and the flow path resistance Rs2 of the liquid outflow path 14b satisfies the following formula (7).

Rs2≈Rs1 (7)

Here, the flow path resistance Rs1 in the formula (7) is a flow path resistance value of ink supplied from the manifold 100a to the first pressure generation chamber 12a on the ink supply side (on the liquid supply path 14a side), and the flow path resistance Rs2 in the formula (7) is a flow path resistance value of ink flowing out from the second pressure generation chamber 12b to the manifold 100b on the ink outflow side (on the liquid outflow path 14b side). In general, the flow path resistance Rs1 and the flow path resistance Rs2 can be obtained in the following manner. When the flow path has a hollow rectangular parallelepiped shape, the flow path resistance Rs1 and the flow path resistance Rs2 can be obtained by (12 μl/wh³). When the flow path has a cylindrical body, the flow path resistance Rs1 and the flow path resistance Rs2 can be obtained by (8 μl/πr⁴). In the flow path resistance Rs1 and the flow path resistance Rs2, μ is the viscosity of ink, l is the length of the flow path, w is the width of the flow path, h is the height of the flow path, and r is the radius of the flow path. The approximation of the shape of flow path is as described above.

When designing a flow path of the recording head 1 in the manner of formula (7), it is desirable that a resistance difference Rs₂₋₁ (=Rs2−Rs1) between the flow path resistance Rs1 and the flow path resistance Rs2 is close to zero (the resistance difference is substantially zero). Specifically, a range of difference of the flow path resistance Rs1 with respect to the flow path resistance Rs2 may be within ±10%, may preferably be ±5%, and may more preferably be ±3%.

When the flow path of the recording head 1 is designed so as to satisfy the formula (7), the resistance difference between the flow path resistance Rs1 and the flow path resistance Rs2 can be substantially ignored. It is possible to circulate the ink without delay by repeating a process in which the ink supplied to the first pressure generation chamber 12a through the liquid supply path 14a is flown out to the liquid outflow path 14b through the communicating paths 16a, 16b, and 17 and the second pressure generation chamber 12b and the ink is returned to the liquid supply path 14a through the supply pipe 9a and the outflow pipe 9b. On the other hand, when the resistance difference described above is large, that is, when the range of difference of the flow path resistance Rs1 with respect to the flow path resistance Rs2 exceeds ±10%, the circulation of the ink becomes difficult.

It is preferable that the flow path is configured so that a relationship between compliance Cs1 of the first piezoelectric element 300a and compliance Cs2 of the second piezoelectric element 300b satisfies the following formula (8).

Cs2≤Cs1 (8)

Here, the compliance Cs1 of the first piezoelectric element 300a in the formula (8) is an index indicating the degree of amount of ink that has been supplied to the first pressure generation chamber 12a and is drawn back (flowing back) to the manifold 100a due to absorbing power (softness) of the flexible portion 47 provided to the manifold 100a when the first piezoelectric element 300a is driven and the ink in the first pressure generation chamber 12a is pressed. The compliance Cs2 of the second piezoelectric element 300b is an index indicating the degree of amount of ink that has been supplied from the first pressure generation chamber 12a to the manifold 100b through the second pressure generation chamber 12b and is pushed back to the second pressure generation chamber 12b due to absorbing power (softness) of the flexible portion 47 provided to the manifold 100b.

When the compliance Cs1 of the first piezoelectric element 300a is large, the absorbing power (softness) of the flexible portion 47 provided to the manifold 100a is large, so that the amount of ink drawn back to the manifold 100a is greater than the amount of ink supplied to the first pressure generation chamber 12a. On the other hand, when the compliance Cs2 of the second piezoelectric element 300b is large, the absorbing power (softness) of the flexible portion 47 provided to the manifold 100b is large and the ink is easily flown to the manifold 100b, so that the amount of discharged ink increases.

In the present embodiment, it is possible to prevent discharge of ink from the nozzle opening 21 due to drive of the first piezoelectric element 300a by defining a relationship between the compliance Cs1 and the compliance Cs2 as shown in the formula (8) by designing so that outflow of ink to the manifold 100b is limited (the amount of ink flowing back increases). As a result, the ink is discharged from the nozzle opening 21 by drive of the second piezoelectric element 300b.

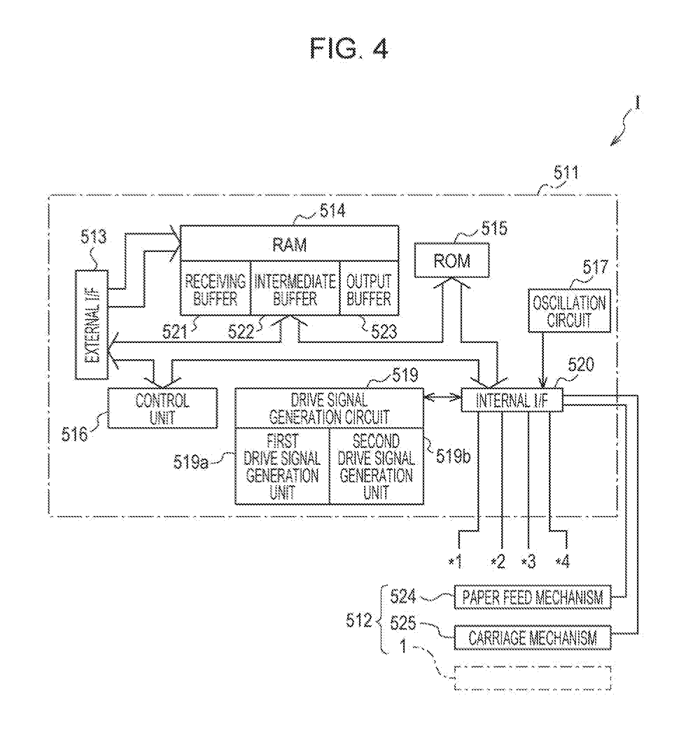

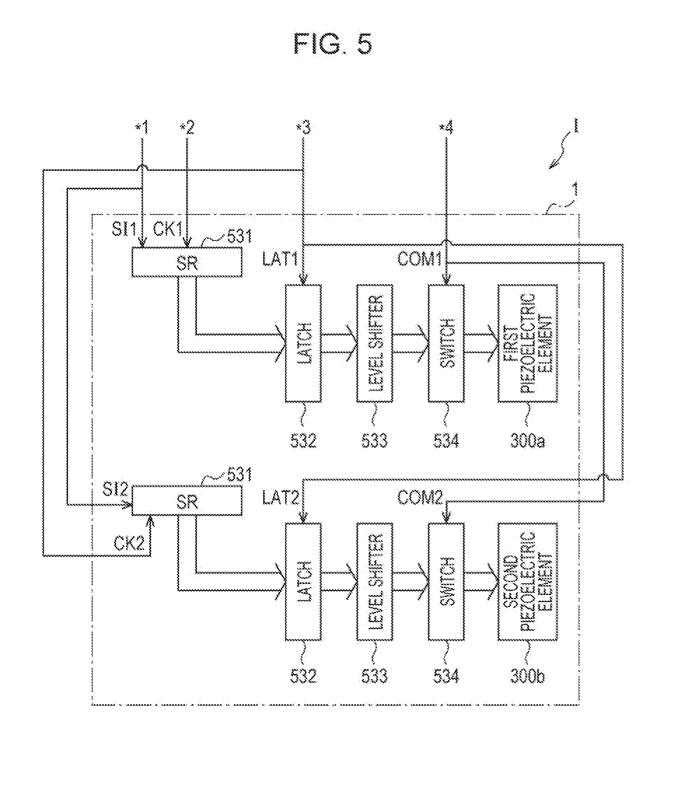

Next, control of the recording head mounted on the recording apparatus will be described with reference to FIGS. 4 and 5. FIGS. 4 and 5 are block diagrams showing a control configuration example of the recording head of the first embodiment.

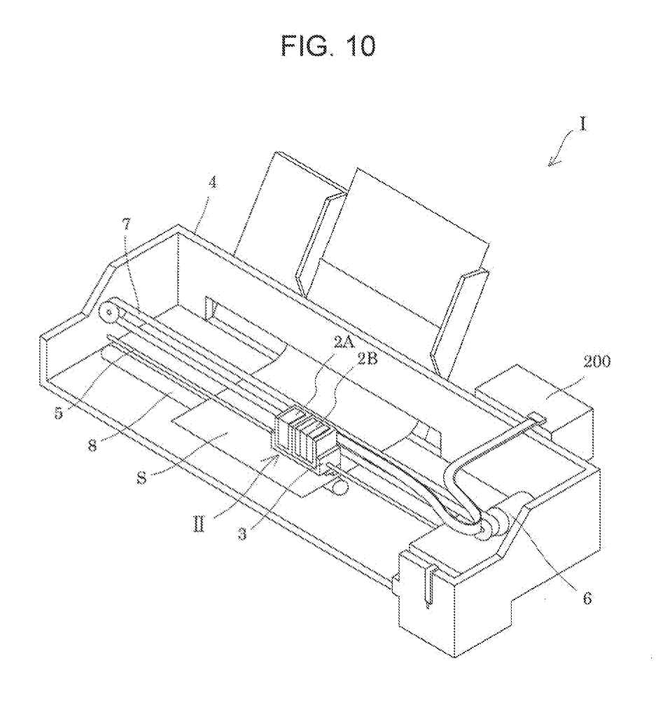

As shown in the drawings, the recording apparatus I (see FIG. 10) that drives the recording head 1 is roughly composed of a printer controller 511 and a print engine 512. The printer controller 511 includes an external interface (external I/F) 513, a RAM 514 that temporarily stores various data, a ROM 515 that stores a control program and the like, a control unit 516 including a CPU and the like, an oscillation circuit 517 that generates a clock signal, a drive signal generation circuit 519 that generates a drive signal for supplying ink to the recording head 1, and an internal interface (internal I/F) 520 that transmits dot pattern data (bitmap data) or the like developed based on the drive signal and print data to the print engine 512. The drive signal generation circuit 519 of the present embodiment has a first drive signal generation unit 519a that generates a drive signal for driving the first piezoelectric element 300a and a second drive signal generation unit 519b that generates a drive signal for driving the second piezoelectric element 300b.

The external I/F 513 receives print data including, for example, character codes, a graphic function, image data, and the like from a host computer not shown in the drawings. Further, a busy signal (BUSY) and an acknowledge signal (ACK) are outputted to the host computer or the like through the external I/F 513.

The RAM 514 functions as a receiving buffer 521, an intermediate buffer 522, an output buffer 523, and a work memory not shown in the drawings. The receiving buffer 521 temporarily stores print data received by the external I/F 513. The intermediate buffer 522 stores intermediate code data converted by the control unit 516. The output buffer 523 stores dot pattern data. The dot pattern data is composed of character print data obtained by decoding (translating) gradation data.

The ROM 515 stores font data, graphic functions, and the like in addition to a control program (control routine) for performing various data processing.

The control unit 516 reads out print data in the receiving buffer 521 and stores intermediate code data obtained by converting the print data into the intermediate buffer 522. Further, the control unit 516 analyzes intermediate code data read out from the intermediate buffer 522, refers to the font data, the graphic functions, and the like stored in the ROM 515, and develops the intermediate code data into dot pattern data. Then, the control unit 516 performs necessary decoration processing and thereafter stores the developed dot pattern data into the output buffer 523. Further, the control unit 516 functions also as a waveform setting means and sets a waveform shape of a drive signal generated from the first drive signal generation unit 519a and the second drive signal generation unit 519b in the drive signal generation circuit 519 by controlling the first drive signal generation unit 519a and the second drive signal generation unit 519b. The control unit 516 configures a drive means along with the drive circuit 120 and the like. The recording apparatus I may be an apparatus including at least the drive means. In the present embodiment, the recording apparatus I is illustrated as an apparatus including the printer controller 511.

When dot pattern data corresponding to one line of the recording head 1 is obtained, the dot pattern data of the one line is outputted to the recording head 1 through the internal I/F 520. When dot pattern data of one line is outputted from the output buffer 523, the intermediate code data that has been developed is deleted from the intermediate buffer 522, and development processing of the next intermediate code data is performed.

The print engine 512 includes the recording head 1, a paper feed mechanism 524, and a carriage mechanism 525. The paper feed mechanism 524 is composed of a paper feed motor and the like not shown in the drawings. The paper feed mechanism 524 sequentially feeds out recording media such as recording sheets S in interlocking with a recording operation of the recording head 1. The paper feed mechanism 524 relatively moves a recording medium in a sub-scanning direction.

The carriage mechanism 525 is composed of a carriage 3 where the recording head 1 can be mounted and a carriage drive unit that makes the carriage 3 travel along a main scanning direction. The carriage mechanism 525 makes the recording head 1 move in the main scanning direction by making the carriage 3 travel. As described above, the carriage drive unit is composed of a drive motor 6, a timing belt 7, and the like.

The recording head 1 has a large number of nozzle openings 21 along the sub-scanning direction and discharges ink droplets from each nozzle opening 21 at a timing specified by dot pattern data or the like. The first piezoelectric element 300a and the second piezoelectric element 300b of the recording head 1 are supplied with electrical signals, for example, drive signals (COM1, COM2) described later, recording data (SI1, SI2), and the like through external wirings not shown in the drawings. In the printer controller 511 and the print engine 512 configured as described above, the printer controller 511 and the drive circuit 120 having latches 532, level shifters 533, and switches 534, which selectively input drive signals having predetermined drive waveforms outputted from the first drive signal generation unit 519a and the second drive signal generation unit 519b of the drive signal generation circuit 519 into the first piezoelectric element 300a and the second piezoelectric element 300b, are a drive means (drive system) that applies predetermined drive signals to the first piezoelectric element 300a and the second piezoelectric element 300b.

These shift registers (SRs) 531, latches 532, level shifters 533, and switches 534, first piezoelectric element 300a, and second piezoelectric element 300b are provided for each nozzle opening 21 of the recording head 1, and these SRs 531, latches 532, level shifters 533, and switches 534 generate a drive pulse from a discharge drive signal and a relaxation drive signal generated by the first drive signal generation unit 519a and the second drive signal generation unit 519b of the drive signal generation circuit 519. Here, the drive pulse is an applied pulse that is actually applied to the first piezoelectric element 300a and the second piezoelectric element 300b.

In such a recording head 1, first, recording data (SI) configuring dot pattern data are serially transmitted from the output buffer 523 to the SRs 531 and sequentially set in the SRs 531 in synchronization with clock signals (CK1, CK2) from the oscillation circuit 517. In this case, first, data of the most significant bits in character print data of all the nozzle openings 21 are serially transmitted, and when the serial transmission of the data of the most significant bits is completed, data of the second most significant bits are serially transmitted. Thereafter, data of lower bits are sequentially and serially transmitted.

When recording data of the bits of all the nozzles are set in the SRs 531, the control unit 516 outputs latch signals (LAT1, LAT2) to the latches 532 at a predetermined timing. The latches 532 latch the character print data set in the SRs 531 by the latch signals. The recording data (LATout) latched by the latches 532 are applied to the level shifters 533 which are voltage amplifiers. For example, when the recording data is “1”, the level shifters 533 raise voltage of the recording data to a voltage value at which the switches 534 can be driven, for example, several tens of volt. The recording data whose voltages are raised are applied to the switches 534, and the switches 534 become a connection state by the recording data.

The switches 534 are applied with also the drive signals (COM1, COM2) generated by the first drive signal generation unit 519a and the second drive signal generation unit 519b of the drive signal generation circuit 519, and when the switches 534 selectively become a connection state, drive signals are selectively applied to the first piezoelectric element 300a and the second piezoelectric element 300b connected to the switches 534. In this way, in the illustrated recording head 1, it is possible to control whether or not to apply discharge drive signals to the first piezoelectric element 300a and the second piezoelectric element 300b according to the recording data. For example, in a period when the recording data is “1”, the switches 534 become a connection state by the latch signals (LAT1, LAT2), so that a drive signal (COMout) can be supplied to the first piezoelectric element 300a and the second piezoelectric element 300b, and the first piezoelectric element 300a and the second piezoelectric element 300b are displaced (deformed) by the supplied drive signal. On the other hand, in a period when the recording data is “0”, the switches 534 become a non-connection state, so that the supply of the drive signal to the first piezoelectric element 300a and the second piezoelectric element 300b is interrupted. In the period when the recording data is “0”, the first piezoelectric element 300a and the second piezoelectric element 300b maintain previous potentials, so that a previous displacement state is maintained.

The first piezoelectric element 300a and the second piezoelectric element 300b described above are the first piezoelectric element 300a and the second piezoelectric element 300b in a flexural vibration mode. When the first piezoelectric element 300a and the second piezoelectric element 300b in the flexural vibration mode are used, the piezoelectric layers 70 shrink in a direction perpendicular to a voltage (in a direction of the piezoelectric element holding portion 31) along with application of the voltage, so that the first piezoelectric element 300a, the second piezoelectric element 300b, and the vibration plates 50 bend into the first pressure generation chamber 12a and the second pressure generation chamber 12b. Thereby, the first pressure generation chamber 12a and the second pressure generation chamber 12b are contracted. On the other hand, when the voltage is reduced, the piezoelectric layers 70 expand in the direction of the piezoelectric element holding portion 31, so that the first piezoelectric element 300a, the second piezoelectric element 300b, and the vibration plates 50 bend opposite to the first pressure generation chamber 12a and the second pressure generation chamber 12b. Thereby, the first pressure generation chamber 12a and the second pressure generation chamber 12b are expanded. In such a recording head 1, volumes of the first pressure generation chamber 12a and the second pressure generation chamber 12b change in accordance with charge and discharge of the first piezoelectric element 300a and the second piezoelectric element 300b. It is possible to discharge ink droplets from the nozzle opening 21 by using pressure variation in the first pressure generation chamber 12a and the second pressure generation chamber 12b.

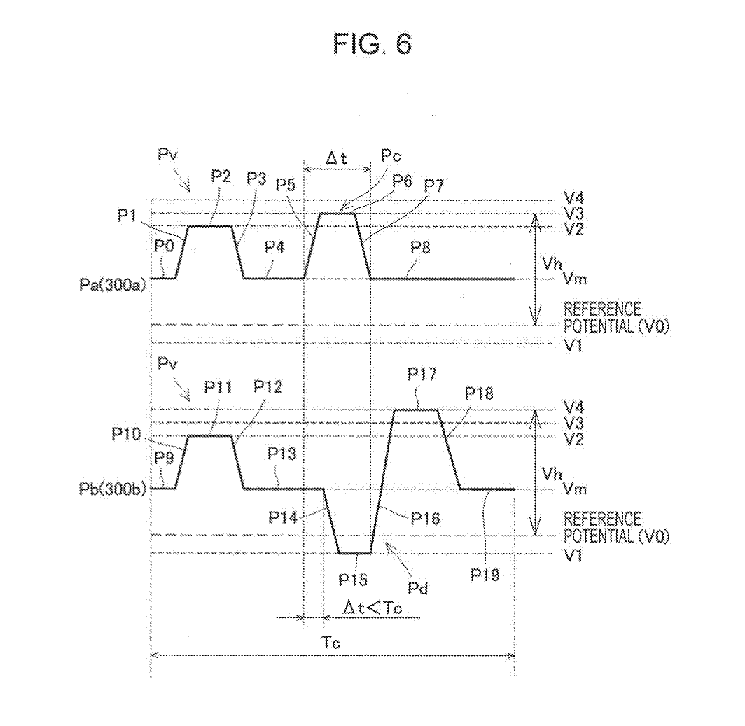

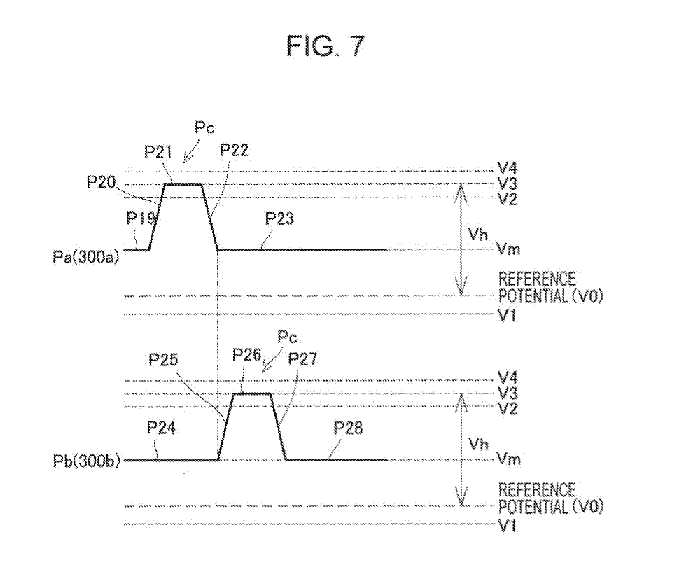

Next, drive waveforms representing the drive signals (COM1, COM2) inputted into the piezoelectric elements of the recording head mounted on the recording apparatus will be described with reference to FIGS. 6 and 7. FIG. 6 is a diagram showing a drive signal example when the recording head of the first embodiment discharges ink. FIG. 7 is a diagram showing a drive signal example when the recording head of the first embodiment does not discharge ink.

As shown in FIG. 6, during operation time of the recording head 1, a drive waveform Pa, which drives the first piezoelectric element 300a that contributes to discharging ink, varies between a reference voltage V0 and a voltage V3. The reference voltage V0 is applied to a common electrode (the first electrode 60 in the present embodiment). For example, when the reference voltage V0 is 5 V, the common electrode is kept at a reference potential of 5 V. A individual electrode (the second electrode 80 in the present embodiment) is applied with three types of voltages: an intermediate voltage Vm, a voltage V2, and a voltage V3. By changing a voltage applied to the individual electrode while keeping the common electrode at the reference potential, the first piezoelectric element 300a can be driven by the drive waveform Pa as shown in FIG. 6. In the drive waveform Pa, a maximum voltage with respect to the reference voltage V0 is Vh.

The drive waveform Pa of the first piezoelectric element 300a includes processes P0 to P8 as described below. The process P0 is a state where drive of the first piezoelectric element 300a is standby (standby state). At this time, the individual electrode is applied with the intermediate voltage Vm. A first voltage change process P1 is a process to cause the first pressure generation chamber 12a to contract. At this time, the voltage applied to the individual electrode changes from the intermediate voltage Vm to the voltage V2. A first hold process P2 is a process to hold for a while a state after the voltage change caused by the first voltage change process P1. At this time, the voltage applied to the individual electrode is held at the voltage V2 without change for a while. A second voltage change process P3 is a process to return the first pressure generation chamber 12a to the standby state again. At this time, the voltage applied to the individual electrode changes from the voltage V2 to the intermediate voltage Vm. A second hold process P4 is a process to hold for a while a state after the voltage change caused by the second voltage change process P3. At this time, the voltage applied to the individual electrode is held at the intermediate voltage Vm without change for a while. A third voltage change process P5 is a process to cause the first piezoelectric element 300a to contract again. At this time, the voltage applied to the individual electrode changes from the intermediate voltage Vm to the voltage V3. A third hold process P6 is a process to hold for a while a state after the voltage change caused by the third voltage change process P5. At this time, the voltage applied to the individual electrode is held at the voltage V3 without change for a while. A fourth voltage change process P7 is a process to return the first pressure generation chamber 12a to the standby state again. At this time, the voltage applied to the individual electrode changes from the voltage V3 to the intermediate voltage Vm. Thereafter, in a process P8 (process P0), drive of the first piezoelectric element 300a is made standby.

In other words, the drive waveform Pa that drives the first piezoelectric element 300a has a micro vibration pulse Pv (from the process P1 to the process P3) that micro-vibrates the first piezoelectric element 300a and a circulation pulse Pc (from the process P5 to the process P7) (first drive signal) for maintaining circulation of ink. The first piezoelectric element 300a is driven by such a drive waveform Pa.

A drive waveform Pb, which drives the second piezoelectric element 300b that discharges ink, varies between a minimum voltage V1 and a maximum voltage Vh. The individual electrode is applied with four types of voltages: the minimum voltage V1, the intermediate voltage Vm, the voltage V2, and the maximum voltage Vh. By changing a voltage applied to the individual electrode while keeping the common electrode at the reference potential, the second piezoelectric element 300b can be driven by the drive waveform Pb as shown in FIG. 6. In the drive waveform Pb, a maximum voltage with respect to the reference voltage V0 is Vh.

The drive waveform Pb of the second piezoelectric element 300b includes processes P9 to P19 as described below. The processes from P9 to P13 correspond to the processes from P0 to P4 in the drive waveform Pa of the first piezoelectric element 300a, so that the description thereof will be omitted. A third voltage change process P14 is a process to cause the first pressure generation chamber 12a to contract. At this time, the voltage applied to the individual electrode changes from the intermediate voltage Vm to the minimum voltage V1. A third hold process P15 is a process to hold for a while a state after the voltage change caused by the third voltage change process P14. At this time, the voltage applied to the individual electrode is held at the minimum voltage V1 without change for a while. A fourth voltage change process P16 is a process to cause the second piezoelectric element 300b to expand. At this time, the voltage applied to the individual electrode changes from the minimum voltage V1 to a voltage V4. A fourth hold process P17 is a process to hold for a while a state after the voltage change caused by the fourth voltage change process P16. At this time, the voltage applied to the individual electrode is held at the maximum voltage Vh without change for a while. A fifth voltage change process P18 is a process to return the second piezoelectric element 300b to the standby state again. At this time, the voltage applied to the individual electrode changes from the maximum voltage Vh to the intermediate voltage Vm. Thereafter, in a process P19 (process P9), drive of the second piezoelectric element 300b is made standby.

In other words, the drive waveform Pb that drives the second piezoelectric element 300b has a micro vibration pulse Pv (from the process P10 to the process P12) that micro-vibrates the second piezoelectric element 300b and a discharge pulse Pd (from the process P14 to the process P18) (second drive signal) for discharging ink from the nozzle opening 21. The second piezoelectric element 300b is driven by such a drive waveform Pb.

As described above, in the nozzle opening 21 from which ink is discharged, the first piezoelectric element 300a and the second piezoelectric element 300b are micro-vibrated by the micro vibration pulse Pv, and after waiting for a while, pulses different from each other are applied to the first piezoelectric element 300a and the second piezoelectric element 300b, respectively. First, the circulation pulse Pc for maintaining circulation of ink is applied to the first piezoelectric element 300a, and after a predetermined period of time (for example, Δt), the discharge pulse Pd for discharging ink from the nozzle opening 21 is applied to the second piezoelectric element 300b, and thereby a predetermined image can be formed on a recording sheet S (see FIG. 10). A drive timing of the first piezoelectric element 300a and a drive timing of the second piezoelectric element 300b are shifted from each other by a predetermined period of time, and thereby ink can be efficiently circulated without stagnation of circulation of ink due to discharge of ink.

On the other hand, the drive waveforms Pa and Pb shown in FIG. 7 are applied to the first piezoelectric element 300a and the second piezoelectric element 300b that do not discharge ink in order to maintain circulation of ink. The drive waveforms Pa and Pb have the circulation pulse Pc for maintaining circulation of ink. The drive waveforms Pa and Pb in this case include processes from P19 to P23 and processes from P24 to P28. However, these processes correspond to the processes from P4 to P8 in the drive waveform Pa of the first piezoelectric element 300a described above, so that the description thereof will be omitted.

In the present embodiment, it is preferable to micro-vibrate ink near the nozzle opening 21 by applying the micro vibration pulse Pv to the first piezoelectric element 300a and the second piezoelectric element 300b before discharging ink. Thereby, the ink near the nozzle opening 21 is more easily flown by the micro vibration, so that it is possible to maintain circulation of ink by reliably suppressing thickening of ink near the nozzle opening 21 and sedimentation of ink components. Further, it is possible to return the ink components sedimented near the nozzle opening 21 (sedimented ink components) to inside of the ink. Thereby, the sedimented ink components are dissolved and the ink can be efficiently refreshed.

As described above, in the nozzle opening 21 that does not discharge ink, the circulation pulse Pc is applied to the first piezoelectric element 300a, and thereafter the circulation pulse Pc is applied to the second piezoelectric element 300b, so that the circulation of ink is maintained. Regarding the nozzle opening 21 that does not discharge ink, ink flows more smoothly by sequentially driving the first piezoelectric element 300a and the second piezoelectric element 300b so as to maintain the circulation of ink.

In the present embodiment, the micro vibration pulse is applied to the first piezoelectric element 300a and the second piezoelectric element 300b before discharging ink. However, the application of the micro vibration pulse is not limited to this. For example, the micro vibration pulse may be applied to one of the piezoelectric elements according to a thickening state and a sedimentation state of the ink. Alternatively, the micro vibration pulse may be applied after the ink is circulated. Further, the micro vibration pulse may be applied to one of the first piezoelectric element 300a and the second piezoelectric element 300b of the nozzle opening 21 that does not discharge ink.

(Circulating Method of Liquid Ejecting Head)

Next, an ink circulating method using the recording head 1 having the configuration described above will be described. During standby time of the apparatus, the recording head 1 stops discharge of ink and circulates the ink. Specifically, the recording head 1 circulates the ink by repeating a process in which ink supplied to the first pressure generation chamber 12a through the liquid supply path 14a is flown out to the liquid outflow path 14b through the communicating paths 16a, 16b, and 17 and the second pressure generation chamber 12b and the ink is returned to the liquid supply path 14a through the supply pipe 9a and the outflow pipe 9b that are a liquid circulating path. Thereby, smooth circulation can be performed.

(Discharge Method of Liquid Ejecting Head)

Next, an ink discharge method using the recording head 1 having the configuration described above will be described. During operation time of the apparatus, the recording head 1 discharges ink while circulating the ink. Specifically, ink from the ink tank 9 is supplied to the supply path 42 through the supply pipe 9a. Thereafter, the drive means (the drive circuit 120 and the like) outputs the drive waveform Pa that drives the first piezoelectric element 300a, then waits for a predetermined period of time (for example, t seconds), and thereafter outputs the drive waveform Pb that drives the second piezoelectric element 300b, so that the drive means sequentially drives the first piezoelectric element 300a and the second piezoelectric element 300b. Thereby, the ink supplied to the supply path 42 is supplied from the manifold 100a to the communicating path 16b through the first pressure generation chamber 12a, the communicating path 16a, and the communicating path 17, and the ink is discharged from the nozzle opening 21. The recording head 1 circulates ink when discharging ink, so that the recording head 1 can reliably suppress thickening of ink near the nozzle opening 21 and sedimentation of components of the ink and prevent degradation of ink discharge characteristics. Thereby, even after a certain period of time has elapsed, the ink discharge characteristics can be substantially uniformized, so that it is possible to suppress variation of discharge characteristics and improve liquid ejection quality.

### Second Embodiment

(Liquid Ejecting Head)

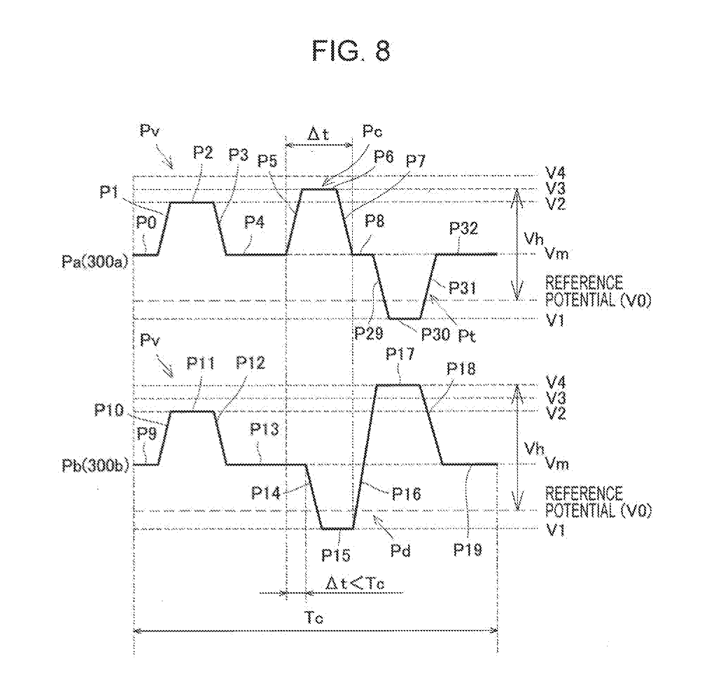

FIG. 8 is a diagram showing a drive signal example when a recording head of a second embodiment discharges ink. In the present embodiment, the first piezoelectric element 300a and the second piezoelectric element 300b of the recording head 1 having the configuration described above may be driven by using drive waveforms representing drive signals (COM1, COM2) as shown in FIG. 8. FIG. 8 shows a drive waveform Pa which drives the first piezoelectric element 300a that contributes to discharging ink during operation time of the recording head 1 and a drive waveform Pb which drives the second piezoelectric element 300b. These drive waveforms are the same as the drive waveform Pa and the drive waveform Pb of the first embodiment except that processes P29 to P32 are added after the process P8 of the drive waveform Pa.

A fourth hold process P8 is a process to hold for a while a state after the voltage change caused by the fourth voltage change process P7. At this time, the voltage applied to the individual electrode is held at the intermediate voltage Vm without change for a while. A fifth voltage change process P29 is a process to cause the first pressure generation chamber 12a to expand. At this time, the voltage applied to the individual electrode changes from the intermediate voltage Vm to the reference voltage V0. A fifth hold process P30 is a process to hold for a while a state after the voltage change caused by the fifth voltage change process P29. At this time, the voltage applied to the individual electrode is held at the reference voltage V0 without change for a while. A sixth voltage change process P31 is a process to return the first pressure generation chamber 12a to the standby state again. At this time, the voltage applied to the individual electrode changes from the reference voltage V0 to the intermediate voltage Vm. Thereafter, in a process P32 (process P0), drive of the first piezoelectric element 300a is made standby.

In other words, the drive waveform Pa that drives the first piezoelectric element 300a has a micro vibration pulse Pv (from the process P1 to the process P3) that micro-vibrates the first piezoelectric element 300a, a circulation pulse Pc (from the process P5 to the process P7) for maintaining circulation of ink, and a pulse Pt (from the process P29 to the process P31) for preventing ink tailing. The first piezoelectric element 300a is driven by such a drive waveform Pa.

In the present embodiment, when the recording head 1 discharges ink, it is preferable to drive the first piezoelectric element 300a so as to prevent the ink tailing by outputting the drive waveform Pa within a natural period Tc of the recording head 1 after outputting the drive waveform Pb to drive the second piezoelectric element 300b. Specifically, the process P29 of the drive waveform Pa is started before the process P16 of the drive waveform Pb is completed. In detail, immediately after the second piezoelectric element 300b is displaced and ink is discharged in the process 16, the first piezoelectric element 300a is displaced to cause the first pressure generation chamber 12a to expand in the process P29 and a force to draw back ink in a direction (+Z direction) opposite to discharge is applied to ink discharged from the nozzle opening 21. Thereby, it is possible to draw back a tailing portion which is discharged from the nozzle opening 21 and is located near the nozzle opening 21, so that it is possible to prevent the ink tailing discharged from the nozzle opening 21. This process may be appropriately performed depending on the viscosity of ink and the like. The timing of starting the process P29 of the drive waveform Pa is immediately after the process P16 of the drive waveform Pb (immediately after discharging ink), so that the first piezoelectric element 300a is driven within the natural period Tc of the recording head 1. Further, when the first piezoelectric element 300a is driven within the natural period Tc, it is possible to prevent the ink tailing by displacing the first piezoelectric element 300a to expand/contract the first pressure generation chamber 12a depending on the timing.

### Third Embodiment

(Liquid Ejecting Head)

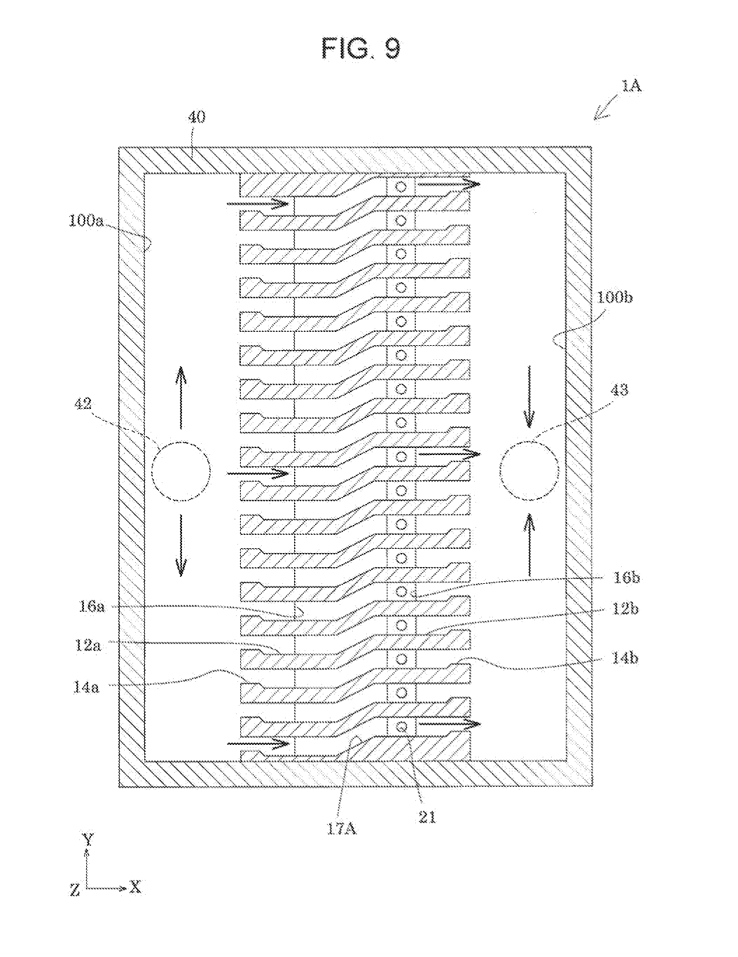

FIG. 9 is a cross-sectional view showing flow paths in a recording head of a third embodiment. As shown in FIG. 9, the recording head 1A of the present embodiment has the same configuration as that of the recording head 1 of the first embodiment except that a configuration of a communicating path 17A is different.

In the recording head 1A, a first column and a second column, where the first pressure generation chambers 12a and the second pressure generation chambers 12b are substantially linearly provided in the parallel arrangement direction, are arranged in different positions in the parallel arrangement direction. Specifically, the second pressure generation chamber 12b is arranged between the first pressure generation chambers 12a in the first column composed of the first pressure generation chambers 12a, and one column of the first pressure generation chambers 12a is shifted from the other column of the second pressure generation chambers 12b by one half of the interval between the first pressure generation chambers 12a adjacent to each other in the parallel arrangement direction. In other words, the first pressure generation chambers 12a and the second pressure generation chambers 12b are arranged in a zigzag pattern. According to the zigzag arrangement, the liquid outflow paths 14b provided in the substrate 10, the communicating paths 16b provided in the communicating plate 15, and the nozzle openings 21 provided in the nozzle plate 20 are shifted from a column of the liquid supply paths 14a by one half of the interval. Regarding the communicating path 17A, one end portion communicated with the first pressure generation chamber 12a through the communicating path 16a is shifted from the other end portion communicated with the second pressure generation chamber 12b through the communicating path 16b by one half of the interval, so that the communicating path 17A is inclined in an XY plane. Thereby, it is possible to integrate the first piezoelectric elements 300a and the second piezoelectric elements 300b corresponding to the first pressure generation chambers 12a and the second pressure generation chambers 12b, so that it is possible to double the resolution.

Although not shown in the drawings, it is possible to configure the recording head 1A so that two second pressure generation chambers 12b are communicated with one first pressure generation chamber 12a through a communicating path. In this configuration, the communicating path may be formed into a path having a two-pronged structure. Thereby, it is possible to integrate piezoelectric elements and improve resolution.

### Other Embodiments

So far, the embodiments of the present invention have been described. However, a basic configuration of the present invention is not limited to the embodiments described above. For example, although in the embodiments described above, a pressure generation means that generates pressure variation in a pressure generation chamber is described by using a thin film type piezoelectric element, the pressure generation means is not limited to the thin-film type piezoelectric element. For example, it is possible to use a thick film type piezoelectric element formed by a method of bonding a green sheet or the like and a vertical vibration type piezoelectric element where piezoelectric materials and electrode forming materials are alternately laminated and the materials are extended and contracted in an axis direction. Further, as a pressure generation means, it is possible to use an apparatus where a heater element is arranged in a pressure generation chamber and droplets are discharged from a nozzle opening by bubbles generated by heat from the heater element, and a so-called electrostatic actuator that generates static electricity between a vibration plate and an electrode, deforms the vibration plate by an electrostatic force, and discharges droplets from a nozzle opening.

The inkjet type recording head (recording head) 1 described above constitutes a part of an inkjet type recording head unit (head unit) and is mounted on an inkjet type recording apparatus (recording apparatus). FIG. 10 is a perspective view showing an overview of an example of the inkjet type recording apparatus. As shown in FIG. 10, in a recording apparatus I, head units II are detachably provided to cartridges 2A and 2B. The cartridges 2A and 2B constitute an ink supply means. The head unit II has a plurality of recording heads 1 and is mounted on a carriage 3. The carriage 3 is provided to a carriage shaft 5 attached to an apparatus main body 4 so as to be movable in a shaft direction. The head units II and the carriage 3 are configured to be able to discharge, for example, a black ink composition and a color ink composition.

A driving force of a drive motor 6 is transmitted to the carriage 3 through a plurality of gears not shown in FIG. 10 and a timing belt 7, and the carriage 3 mounted with the head units II is moved along the carriage shaft 5. On the other hand, the apparatus main body 4 is provided with a transport roller 8 as a transport means, and a recording sheet S, which is a recording medium such as paper, is transported by the transport roller 8. The transport means that transports the recording sheet S is not limited to a transport roller but may be a belt, a drum, or the like.

In the recording head 1, a piezoelectric element is used as a piezoelectric element apparatus. By using the piezoelectric element, it is possible to avoid degradation of various characteristics (durability, ink ejecting characteristics, and the like) of the recording apparatus I.

In the example described above, a serial type recording apparatus that mounts a recording head on a carriage that moves in a direction (main scanning direction) crossing a transport direction of a recording sheet, and performs printing while moving the recording head in the main scanning direction is illustrated. However, the recording apparatus is not limited to the apparatus described above. For example, the present invention can be applied to a line type recording apparatus where a recording head is fixed and which performs printing by only transporting a recording sheet.

In the present embodiment, a recording apparatus where a liquid storage means such as an ink cartridge is fixed to each recording head, a head unit, a carriage, or the like is illustrated. However, the recording apparatus is not limited to the above recording apparatus. For example, the present invention can be applied to a recording apparatus where the liquid storage means is fixed to an apparatus main body.

In the present embodiment, an inkjet type recording apparatus is described as an example of the liquid ejecting apparatus. However, the present invention aims at all liquid ejecting apparatuses that include a liquid ejecting head, and, of course, the present invention can be applied to liquid ejecting apparatuses that include a liquid ejecting head that ejects liquid other than ink. Examples of other liquid ejecting heads include various recording heads used for an image recording apparatus such as a printer, a color material ejecting head used for manufacturing a color filter of a liquid crystal display and the like, an electrode material ejecting head used for forming electrodes of an organic EL display, a FED (field emission display), and the like, and a bioorganic material ejecting head used for manufacturing biochips.

### REFERENCE SIGNS LIST

I RECORDING APPARATUS
II HEAD UNIT
S RECORDING SHEET
1, 1A RECORDING HEAD
2A, 2B CARTRIDGE
3 CARRIAGE
4 APPARATUS MAIN BODY
5 CARRIAGE SHAFT
6 DRIVE MOTOR
7 TIMING BELT
8 TRANSPORT ROLLER
9 INK TANK
9a SUPPLY PIPE
9b OUTFLOW PIPE
10 SUBSTRATE
12a FIRST PRESSURE GENERATION CHAMBER
12b SECOND PRESSURE GENERATION CHAMBER
14a LIQUID SUPPLY PATH
14b LIQUID OUTFLOW PATH
15 COMMUNICATING PLATE
16a, 16b, 17, 17A COMMUNICATING PATH
20 NOZZLE PLATE
21 NOZZLE OPENING
30 PROTECTIVE SUBSTRATE
31 PIEZOELECTRIC ELEMENT HOLDING PORTION
32 THROUGH HOLE
40 COMPLIANCE SUBSTRATE
41 RECESSED PORTION
42 SUPPLY PATH
43 OUTFLOW PATH
45 SEALING FILM
46 SPACE PORTION
47 FLEXIBLE PORTION
48 CONNECTION PORT
49 WALL PORTION
50 VIBRATION PLATE
51 ELASTIC FILM
52 INSULATOR FILM
60 FIRST ELECTRODE
70 PIEZOELECTRIC LAYER
80 SECOND ELECTRODE
90 LEAD ELECTRODE
100a, 100b MANIFOLD
120 DRIVE CIRCUIT
121 WIRING SUBSTRATE
122 CONNECTION SUBSTRATE
123 CONNECTOR
300a FIRST PIEZOELECTRIC ELEMENT
300b SECOND PIEZOELECTRIC ELEMENT
511 PRINTER CONTROLLER
512 PRINT ENGINE
513 EXTERNAL INTERFACE (EXTERNAL I/F)
514 RAM
515 ROM
516 CONTROL UNIT
517 OSCILLATION CIRCUIT
519 DRIVE SIGNAL GENERATION CIRCUIT
519a FIRST DRIVE SIGNAL GENERATION UNIT
519b SECOND DRIVE SIGNAL GENERATION UNIT
520 INTERNAL INTERFACE (INTERNAL I/F)
521 RECEIVING BUFFER
522 INTERMEDIATE BUFFER
523 OUTPUT BUFFER
524 PAPER FEED MECHANISM
525 CARRIAGE MECHANISM
531 SHIFT REGISTER (SR)
532 LATCH
533 LEVEL SHIFTER
534 SWITCH

1. A liquid ejecting head comprising:
a first pressure generation chamber including a first pressure generation means;
a second pressure generation chamber including a second pressure generation means;
a communicating path that causes the first pressure generation chamber and the second pressure generation chamber to communicate with each other;
a liquid supply path that supplies liquid to the first pressure generation chamber; and
a liquid outflow path that flows out liquid from the second pressure generation chamber,
wherein the liquid ejecting head ejects liquid from a nozzle opening that communicates with the second pressure generation chamber, and
a relationship among an inertance Mn of the nozzle opening, an inertance Ms1 of the liquid supply path, and an inertance Ms2 of the liquid outflow path satisfies a following formula (1):
Mn<Ms2<Ms1 (1).

2. The liquid ejecting head according to claim 1, wherein
a relationship between a flow path resistance Rs1 of the liquid supply path and a flow path resistance Rs2 of the liquid outflow path satisfies a following formula (2):
Rs2≈Rs1 (2).

3. The liquid ejecting head according to claim 1, further comprising:
a liquid circulating path that is connected between the liquid supply path and the liquid outflow path and circulates liquid; and
a drive means that drives the first pressure generation means and the second pressure generation means,
wherein the drive means outputs a first drive signal that drives the first pressure generation means to contract the first pressure generation chamber, thereafter, waits for a predetermined period of time and outputs a second drive signal that drives the second pressure generation means to contract the second pressure generation chamber, and thereby sequentially drives the first pressure generation means and the second pressure generation means.

4. The liquid ejecting head according to claim 3, wherein
the drive means outputs a micro vibration signal that micro-vibrates the first pressure generation means and the second pressure generation means.

5. The liquid ejecting head according to claim 1, wherein
a first column composed of a plurality of the first pressure generation chambers and a second column composed of a plurality of the second pressure generation chambers are provided in parallel, positions of the columns in a direction along each column are different from each other, and the second pressure generation chamber is arranged between the first pressure generation chambers in the first column.

6. The liquid ejecting head according to claim 1, wherein
a relationship between compliance Cs1 of the first pressure generation means and compliance Cs2 of the second pressure generation means satisfies a following formula (3):
Cs2≤Cs1 (3).

7. The liquid ejecting head according to claim 3, wherein
when liquid is discharged, the drive means drives the first pressure generation means by outputting a third drive signal that contracts or expands the first pressure generation chamber within a natural period Tc of the liquid ejecting head after outputting the second drive signal to drive the second pressure generation means.

8. A liquid ejecting apparatus comprising: the liquid ejecting head according to claim 1.

9. A liquid circulating method that circulates liquid in a liquid ejecting head which includes
a first pressure generation chamber including a first pressure generation means,
a second pressure generation chamber including a second pressure generation means,
a communicating path that causes the first pressure generation chamber and the second pressure generation chamber to communicate with each other,
a liquid supply path that supplies liquid to the first pressure generation chamber,
a liquid outflow path that flows out liquid from the second pressure generation chamber, and
a liquid circulating path connected between the liquid supply path and the liquid outflow path, and
which ejects liquid from a nozzle opening that communicates with the second pressure generation chamber,
wherein a liquid ejecting head is used where a relationship among an inertance Mn of the nozzle opening, an inertance Ms1 of the liquid supply path, and an inertance Ms2 of the liquid outflow path satisfies a following formula (4):
Mn<Ms2<Ms1 (4), and
liquid is circulated by repeating a process in which the liquid supplied to the first pressure generation chamber through the liquid supply path is flown out to the liquid outflow path through the communicating path and the second pressure generation chamber and the liquid is returned to the liquid supply path through the liquid circulating path.

10. A liquid discharge method that discharges liquid by using a liquid ejecting head which includes
a first pressure generation chamber including a first pressure generation means,
a second pressure generation chamber including a second pressure generation means,
a communicating path that causes the first pressure generation chamber and the second pressure generation chamber to communicate with each other,
a liquid supply path that supplies liquid to the first pressure generation chamber,
a liquid outflow path that flows out liquid from the second pressure generation chamber, and
a drive means that drives the first pressure generation means and the second pressure generation means, and
ejects liquid from a nozzle opening that communicates with the second pressure generation chamber, and
which is configured so that a relationship among an inertance Mn of the nozzle opening, an inertance Ms1 of the liquid supply path, and an inertance Ms2 of the liquid outflow path satisfies a following formula (5):
Mn<Ms2<Ms1 (5),
wherein the drive means outputs a first drive signal that drives the first pressure generation means, thereafter, waits for a predetermined period of time and outputs a second drive signal that drives the second pressure generation means, and thereby sequentially drives the first pressure generation means and the second pressure generation means to discharge liquid from the nozzle opening.
